(19) United States
(12) Patent Application Publication
(10) Pub. No.: US 2022/0368430 A1
(43) Pub. Date: Nov. 17, 2022

(54) Communication System, Slave Station, and Communication Method

(71) Applicant: Nippon Telegraph and Telephone Corporation, Tokyo (JP)

(72) Inventors: Naoki Miura, Tokyo (JP); Hideyuki Nosaka, Tokyo (JP); Hiroaki Taguchi, Tokyo (JP); Takeshi Komatsu, Tokyo (JP)

(21) Appl. No.: 17/622,135

(22) PCT Filed: Jun. 26, 2019
(86) PCT No.: PCT/JP2019/025383

§ 371 Date: Dec. 22, 2021

(51) Int. Cl. H04B 11/00; G08C 23/02

(52) U.S. Cl. CPC H04B 11/00; G08C 23/02

(57) ABSTRACT

An embodiment communication system includes: one or more slave stations, each of the slave stations including a sensor configured to detect a sensor signal, a controller configured to generate a first electrical signal at a predetermined frequency using the sensor signal, and a sound wave transmitter configured to convert the first electrical signal into a sound wave signal and to emit the sound wave signal; and a master station including a sound wave receiver configured to receive the sound wave signal and to convert the sound wave signal into a second electrical signal, and a controller configured to detect that the sensor of one of the slave stations has detected the sensor signal based on the second electrical signal.

### CROSS-REFERENCE TO RELATED APPLICATION

This application is a national phase entry of PCT Application No. PCT/JP2019/025383, filed on Jun. 26, 2019, which application is hereby incorporated herein by reference.

### TECHNICAL FIELD

The present invention relates to a communication system in a sensor network consisting of a slave station and a master station.

### BACKGROUND

Various services using sensor networks have been provided with the development of information communication technologies. For example, there are services for acquiring various kinds of physical data through attachment to users' bodies and for managing safety operations through attachment to plant equipment (for example, see Patent Literature 1).

A configuration example of a sensor network in the related art is illustrated in FIG. 15. The sensor network in the related art is configured with one or more slave stations and a master station. Each slave station serves as a sensor terminal and performs acquisition of data and inspection of events. Then, the slave station transmits the acquired information and events and further an identification number and the like of the slave station to the master station with radio waves. The master station analyzes the thus obtained data and provides various services to a user. In the sensor network in the related art, radio waves are typically used for communication between the master station and the slave station. For example, radio waves at a frequency of 2.4 GHz band are used for the communication standard such as Wi-Fi (registered trademark).

A typical configuration example of the slave station in the sensor network in the related art is illustrated in FIG. 16. The slave station is configured with a sensor, a control unit, a radio wave emitting unit, and a power supply unit. In the configuration example, the sensor has a function of performing sensing and transmitting a sensed sensor signal to the control unit. The control unit has a function of generating information to be transmitted to the master station based on the received sensor signal and transmitting the generated information as a transmission signal to the radio wave emitting unit.

The radio wave emitting unit has a function of transmitting the received transmission signal with the radio wave to the master station. The power supply unit has a function of supplying power to the sensor, the control unit, and the radio wave emitting unit. The radio wave emitting unit in the configuration example is formed of an electronic circuit with an oscillation circuit and an amplification circuit integrated thereon. In the slave station in the sensor network in the related art, an electronic circuit is typically used to realize communication using radio waves.

### CITATION LIST

### Patent Literature

Patent Literature 1: JP 2017-207851 A

### SUMMARY

### Technical Problem

In a sensor network in the related art, it has been difficult to form a slave station in the sensor network with a transistor using an organic semiconductor or the like and having a low operation frequency. This is because the transistor of an electronic circuit is required to operate at a high frequency in communication using radio waves.

An object of embodiments of the present invention is to provide a communication system that operates with an electronic circuit with a low operation frequency.

### Means for Solving the Problem

An embodiment of the present invention provides a communication system using a sound wave signal for slave-to-master transmission, the communication system including one or a plurality of slave stations and a master station, in which each of the one or plurality of the slave stations includes a sensor configured to detect a sensor signal, a control unit configured to generate a first electrical signal at a predetermined frequency using the sensor signal, and a sound wave emitting unit configured to convert the first electrical signal into a sound wave signal and emit the sound wave signal, and the master station includes a sound wave receiving unit configured to receive the sound wave signal and convert the sound wave signal into a second electrical signal and a control unit configured to detect that the sensor in the slave station has detected the sensor signal based on the second electrical signal.

An embodiment of the present invention provides a communication method performed in a communication system using a sound wave signal for transmission of a signal from one or a plurality of slave stations to a master station, the method including: by each of the slave stations, detecting a sensor signal; generating a first electrical signal at a predetermined frequency using the sensor signal; and converting the first electrical signal into a sound wave signal and emitting the sound wave signal; and by the master station, receiving the sound wave signal; converting the sound wave signal into a second electrical signal; and detecting that the slave station has detected the sensor signal based on the second electrical signal.

### Effects of Embodiments of the Invention

According to embodiments of the present invention, it is possible to provide a communication system that operates with an electronic circuit with a low operation frequency.

### BRIEF DESCRIPTION OF THE DRAWINGS

FIG. 1 is a configuration example of a communication system according to a first embodiment.

FIG. 2 is a configuration example of a slave station according to the first embodiment.

FIG. 3 is a configuration example of a control unit in the slave station according to the first embodiment.

FIG. 4 is a configuration example of a sound wave emitting unit in the slave station according to the first embodiment.

FIG. 5 is a configuration example of a master station according to the first embodiment.

FIG. 6 is another configuration example of the master station according to the first embodiment.

FIG. 7 is a sequence example of a communication method according to the first embodiment.

FIG. 8 is another configuration example of the sound wave emitting unit in the slave station according to the first embodiment.

FIG. 9 is a configuration example of a communication system according to a second embodiment.

FIG. 10 is a configuration example of a master station according to the second embodiment.

FIG. 11 is a configuration example of a communication system according to a third embodiment.

FIG. 12 is a configuration example of a control unit in a slave station according to the third embodiment.

FIG. 13 is a configuration example of a master station according to the third embodiment.

FIG. 14 is another configuration example of the control unit in the slave station according to the third embodiment.

FIG. 15 is a configuration example of a sensor network in the related art.

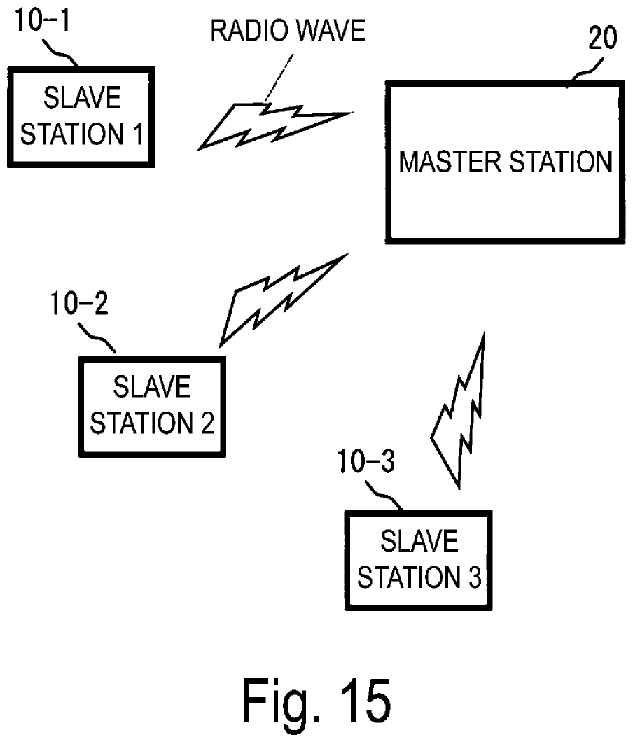

FIG. 16 is a configuration example of a slave station in the sensor network in the related art.

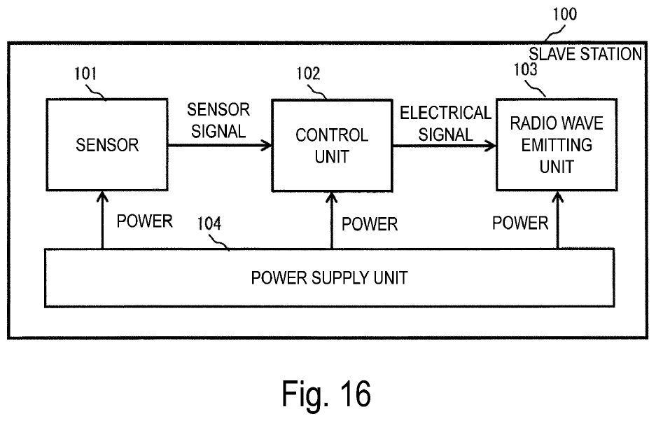

### DETAILED DESCRIPTION OF ILLUSTRATIVE EMBODIMENTS

Hereinafter, embodiments of the present invention will be described based on the drawings. The present invention is not limited to the following embodiments.

### First Embodiment

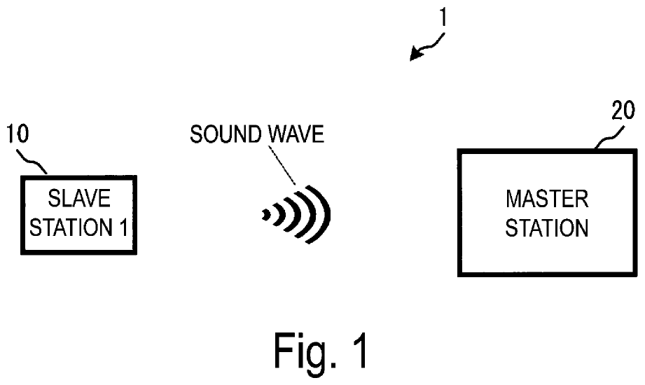

FIG. 1 is a configuration example of a communication system 1 according to a first embodiment. In this configuration example, a sound signal is transmitted from a master station and a slave station to a master station in a one-to-one correspondence. In this configuration example, a slave station 10 is configured to emit a sound wave of about 10 kHz when the slave station 10 detects light to notify a master station 20 of the fact that the slave station 10 has detected light.

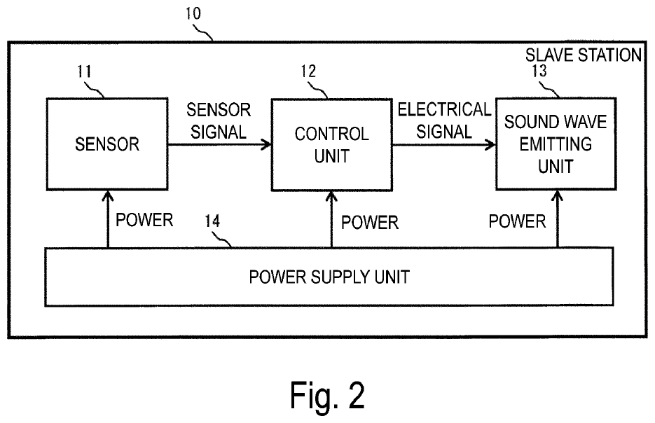

FIG. 2 is a configuration example of the slave station according to the present embodiment. In the configuration example, the slave station 10 is formed of a sensor 11 configured to detect a sensor signal, a control unit 12 configured to generate an electrical signal at a predetermined frequency using the sensor signal, a sound wave emitting unit 13 configured to convert the electrical signal (first electrical signal) generated by the control unit 12 into a sound wave signal and emit the sound wave signal, and a power supply unit 14 configured to supply power to each component.

The configuration example is different from the related art in that a component corresponding to a radio wave emitting unit 103 is formed of the sound wave emitting unit 13. In the configuration example, the power supply unit 14 can be formed of a general button battery or the like. The sensor 11 can be formed of a general photodiode configured to generate a current when the photodiode detects light.

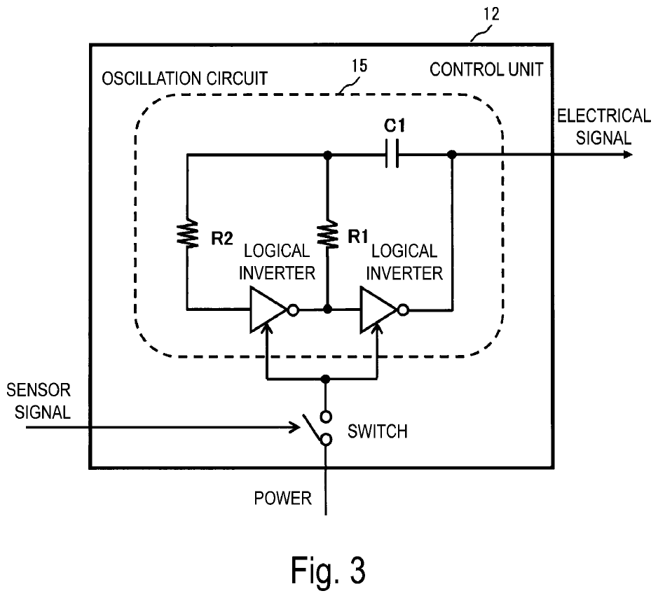

A configuration example of the control unit 12 is illustrated in FIG. 3. The control unit 12 is formed of a switch configured to operate in accordance with a sensor signal and an oscillation circuit 15 configured to generate an electrical signal at a predetermined frequency in accordance with the operation of the switch. In FIG. 3, the oscillation circuit 15 is formed of a general RC oscillation circuit. The RC oscillation circuit is formed of a resistor (R), a capacitor (C), and a logical inverter. In the RC oscillation circuit, it is possible to determine an oscillation frequency in advance with two R (R1 and R2) values and a C value. In the present embodiment, communication using a sound wave signal is performed, and the oscillation frequency of the RC oscillation circuit is thus set to about 10 kHz. Thus, an operation frequency required by a transistor in the logical inverter is also about several tens of kHz, and it is possible to cause the logical inverter to operate even with a transistor with a low operation frequency such as an organic semiconductor.

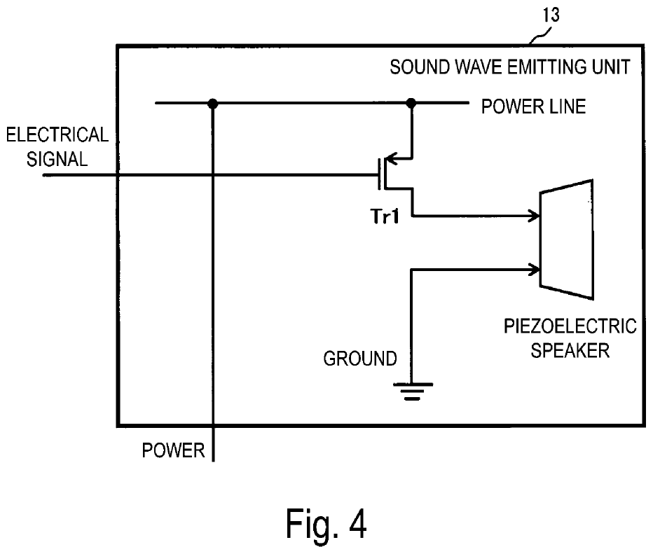

A configuration example of the sound wave emitting unit 13 is illustrated in FIG. 4. The sound wave emitting unit 13 is formed of a piezoelectric speaker configured to convert the electrical signal generated by the control unit 12 into a sound wave signal and transmit the sound wave signal to the master station, and a transistor configured to drive the piezoelectric speaker. Since the operation frequency required by the transistor configured to drive the piezoelectric speaker is also merely several tens of kHz, it is possible to use a transistor with a low operation frequency such as an organic semiconductor.

First, communication operations in the present embodiment will be described. In the slave station 10, when the sensor 11 does not detect light, the sensor signal output from the sensor 11 is not valid, and the switch of the control unit 12 is in an OFF state in a state in which the sensor 11 has not detected light. Thus, no power is supplied to the oscillation circuit 15, no electrical signal is generated, and no sound waves are transmitted to the master station. Because the master station has not received any sound waves from the slave station, it is possible to determine that the slave station has not detected light.

On the other hand, in a state in which the sensor 11 in the slave station 10 has detected light, the sensor signal is valid, and the switch of the control unit 12 is brought into an ON state. In this manner, the power is supplied to the oscillation circuit 15, the RC oscillation circuit 15 performs oscillation, and an electrical signal is generated at a predetermined frequency determined by the R and C values. The electrical signal is converted into a sound wave signal by the piezoelectric speaker and is then transmitted as the sound wave signal to the master station. The master station can detect that the slave station has detected light based on the reception of the sound wave from the slave station.

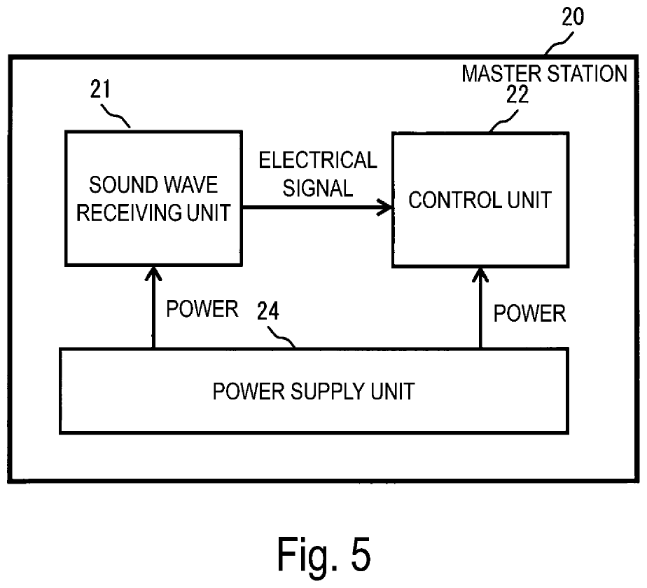

A configuration example of the master station according to the present embodiment is illustrated in FIG. 5. The master station 20 is formed of a sound wave receiving unit 21 configured to receive a sound wave signal and convert the sound wave signal to an electrical signal (second electrical signal), a control unit 22 configured to detect that the sensor 11 in the slave station has detected a sensor signal based on the electrical signal, and a power supply unit 24 configured to supply power to each component. The sound wave receiving unit 21 is formed of a so-called microphone, converts the sound wave signal received from the slave station 10 into an electrical signal, and transmits the electrical signal to the control unit. The control unit 22 detects that the sensor 11 in the slave station 10 has detected a sensor signal based on the electrical signal received from the sound wave receiving unit 21 and executes operations in accordance with an application of the control unit.

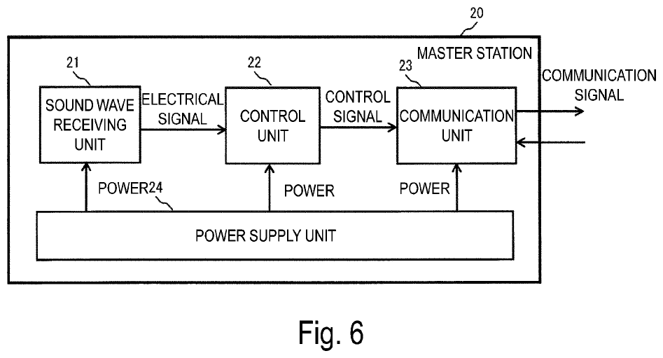

As illustrated in FIG. 6, the master station 20 may further have a communication unit 23 configured to perform communication with a communication device in an upper level. The sound wave receiving unit 21 in the master station 20 may be formed of a microphone constituted by a piezoelectric element, the control unit 22 may be formed of a computer, and the communication unit may be formed of an electronic circuit for wired communication. The master station 20 can be realized by a general computer, an electronic circuit, an electronic component, or the like.

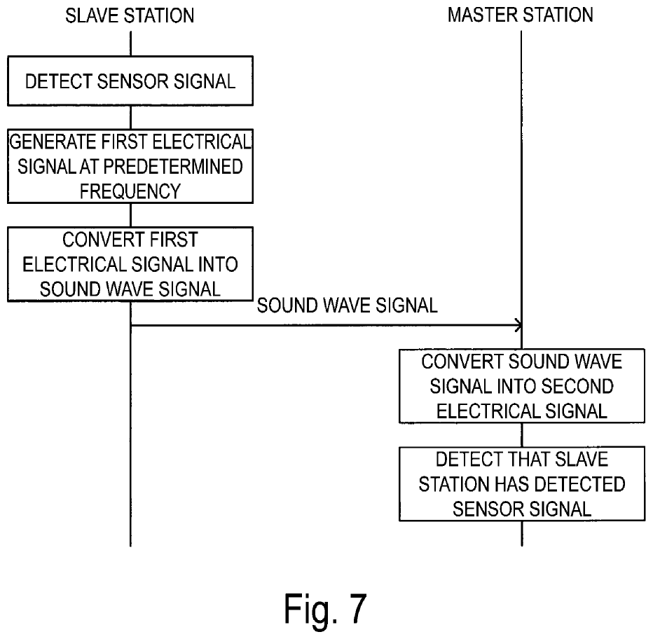

FIG. 7 is sequence example of a communication method according to the first embodiment. In the communication method according to the present embodiment, steps as illustrated in FIG. 7 are executed. In the slave station, a sensor signal becomes valid when the sensor detects light, power is supplied to the oscillation circuit, and an electrical signal at a predetermined frequency (first electrical signal) is generated. The electrical signal is converted into a sound wave signal by the piezoelectric speaker and is then transmitted as the sound wave signal to the master station. On the other side, if the master station receives the sound wave signal transmitted from the slave station, then the master station converts the received sound wave signal into an electrical signal (second electrical signal) and detects that the sensor in the slave station has detected a sensor signal based on the electrical signal obtained by converting the sound wave signal.

As described above, according to the present embodiment, it is possible to enable communication at a low frequency using sound waves caused by oscillation of air and to provide a communication system that operates with an electronic circuit at a low operation frequency.

In the present embodiment, the slave station can be formed of a transistor having a low operation frequency. However, effects obtained by the present embodiment are not limited thereto. For example, it is possible to obtain effects such as an improvement in ease of design due to the low operation frequency, an improvement in noise tolerance (communication quality), and reduction of power consumption. Further, it is possible to use the transistor having a low operation frequency such as an organic semiconductor and thereby to expect effects such as production by a printing process and cost reduction.

In the present embodiment, the example in which the power supply unit is formed of a battery has been described. However, the power supply unit is not limited to the battery and may be any device as long as the device can supply power. For example, an energy harvesting device using light, electromagnetic induction, or oscillation may be used.

In the present embodiment, the example in which the sensor in the slave station is formed of an optical sensor such as a photodiode has been described. However, the sensor is not limited to the optical sensor, and another sensor may be used. For example, the sensor may be formed of a device sensing, for example, temperature, humidity, water, soil constituents, smoke, oscillation, positions, distortions, or mechanical operations (ON/OFF).

In the present embodiment, the example in which the sound wave emitting unit is configured with a piezoelectric speaker has been described. However, the sound wave emitting unit is not limited to the piezoelectric speaker, and another speaker can also be used as long as the speaker is configured to be able to generate sound waves. For example, the sound wave emitting unit may be configured with an electrostatic-type speaker using a capacitor or a magnetic-type speaker using a magnet.

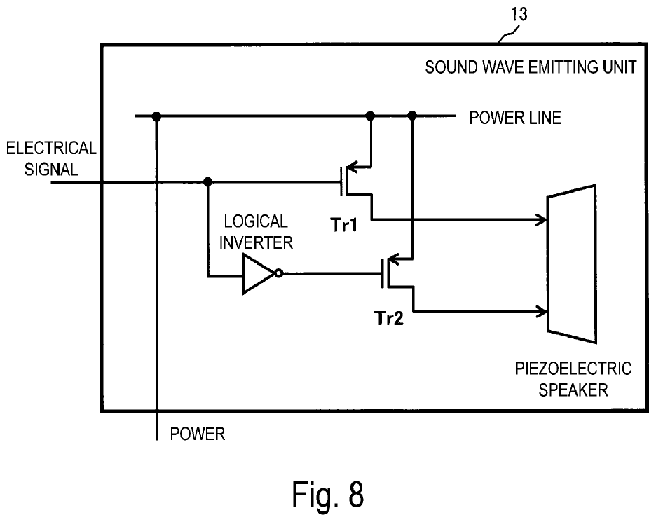

In the present embodiment, the example in which the piezoelectric speaker is driven with one transistor has been described. However, the configuration of the piezoelectric speaker is not limited to the configuration. For example, a configuration in which the piezoelectric speaker is driven using two transistors as in FIG. 8 may be employed.

In the present embodiment, the configuration example in which the RC oscillation circuit is used as the oscillation circuit of the control unit has been described. However, the oscillation circuit is not limited to the RC oscillation circuit and may be configured with an LC oscillation circuit or a solid oscillator such as quartz.

### Second Embodiment

Although the case in which a sound wave signal is transmitted from the master station and the slave station to the slave station in a one-to-one correspondence has been described in the configuration example in the first embodiment, a case in which sound wave signals are transmitted from a plurality of slave stations to a master station in a multiple-to-one correspondence will be described in a second embodiment. The slave station 10 is configured to emit sound waves of about 10 kHz and notify the master station 20 of the fact that the slave station 10 has detected light when the slave station 10 detects light in the second embodiment similarly to the first embodiment.

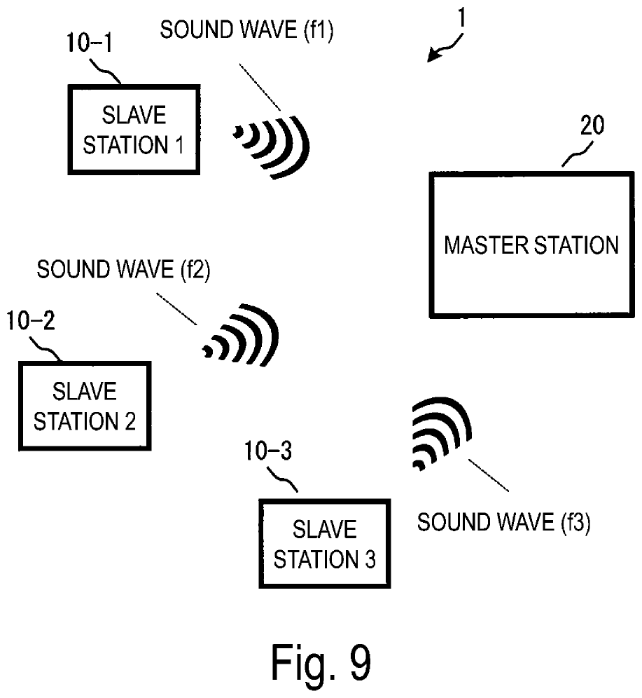

A configuration example of a communication system 1 according to the present embodiment is illustrated in FIG. 9. In the present embodiment, a configuration in which sound waves transmitted by a plurality of slave stations (10-1 to 10-3) are received by the master station 20 is employed. In the present embodiment, the master station 20 is required to be configured to identify each of the slave stations (10-1 to 10-3) such that, even if the plurality of slave stations (10-1 to 10-3) transmit sound waves at the same time, no collision of sound waves occurs. In the present embodiment, a configuration in which the slave stations are identified by allocating mutually different frequencies to the slave stations (10-1 to 10-3) such that collision of sound waves from the plurality of slave stations does not occur is employed.

In the configuration example in FIG. 9, one master station 20 receives sound waves transmitted by three slave stations (10-1 to 10-3). In the configuration example, a frequency f1 is allocated to the slave station 10-1, a frequency f2 is allocated to the slave station 10-2, and a frequency f3 is allocated to the slave station 10-3. Configurations of the slave stations (10-1 to 10-3) according to the present embodiment are similar to the configuration of the slave station in the first embodiment. The oscillation frequency of each of the slave stations (10-1 to 10-3) can be set in advance with the R and C values of the RC oscillation circuit 15 of the control unit 12.

If a unique frequency is allocated to each of the slave stations (10-1 to 10-3), and the master station 20 receives a sound wave at a frequency f1, for example, then the master station 20 can detect that the slave station 10-1 has detected light. Also, in a case in which the master station 20 has received sound waves at a plurality of frequencies, for example, the frequency f1 and the frequency f2 at the same time, the master station 20 can detect that the slave station 10-1 and the slave station 10-2 have detected light.

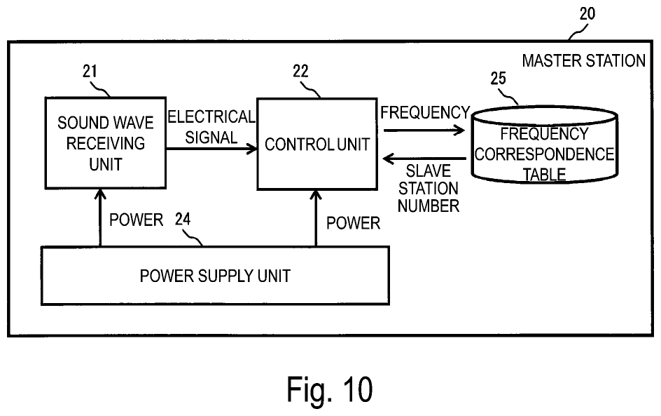

A configuration example of the master station according to the present embodiment is illustrated in FIG. 10. A difference from the first embodiment is that the master station 20 includes a frequency correspondence table 25 between frequencies and slave station numbers. The master station 20 can determine from which slave station the master station 20 has received a sound wave by the control unit 22 checking the frequency of the received sound wave and by the control unit 22 referring to the frequency correspondence table 25.

As described above, according to the present embodiment, it is possible to configure the communication system in which the master station and the slave stations perform communication in one-to-multiple correspondence using sound waves. The master station can identify each of the slave stations by allocating mutually different frequencies to the slave stations such that no collision occurs even in a case in which the plurality of slave stations transmit sound waves at the same time.

### Third Embodiment

A third embodiment relates to a case in which sound signals are transmitted from a plurality of slave stations to a master station in a multiple-to-one correspondence similarly to the second embodiment. The third embodiment is different from the second embodiment in terms of the method in which the master station identifies the slave stations. The slave stations 10 are configured to emit sound waves of about 10 kHz and notify the master station 20 of the fact that the slave stations 10 have detected light when the slave stations 10 detect light in the present embodiment similarly to the first embodiment.

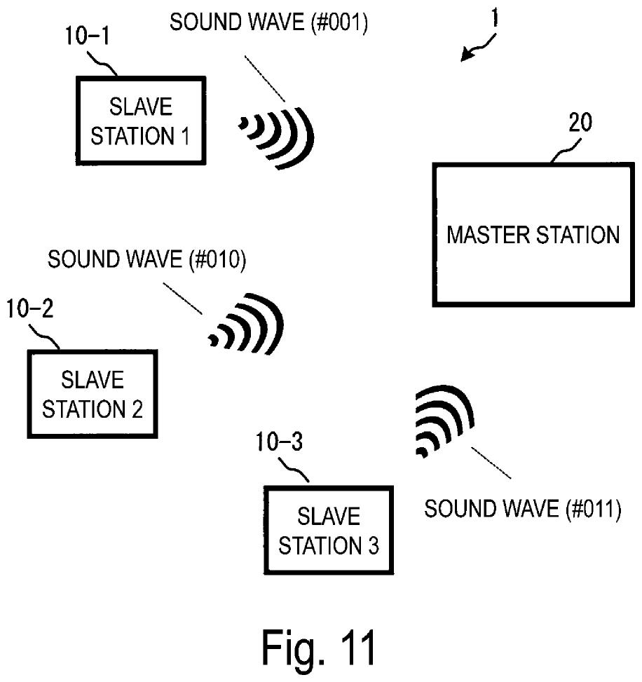

A configuration example of a communication system 1 according to the present embodiment is illustrated in FIG. 11. Although mutually different unique frequencies are allocated to the slave stations (10-1 to 10-3) for the master station 20 to identify the slave stations (10-1 to 10-3) in the second embodiment, the present embodiment is configured such that unique identification numbers are allocated to the slave stations and the slave stations are identified with the identification numbers. In the present embodiment, an identification number #001 is allocated to the slave station 10-1, an identification number #010 is allocated to the slave station 10-2, and a number #011 is allocated to the slave station 10-3, and the slave stations (1o-1 to 10-3) transmit sound signals modulated by the identification numbers to the master station 20. The master station 20 can identify from which slave station the master station 20 has received radio waves with the identification number obtained by demodulating an electrical signal obtained by converting the received sound signal.

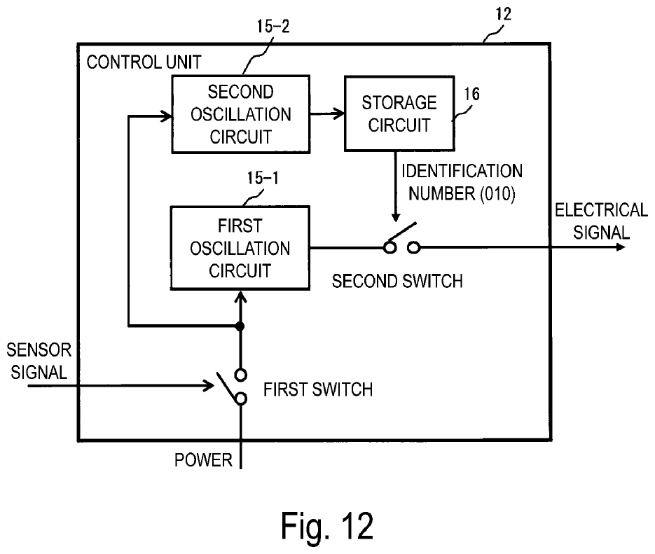

The slave stations (10-1 to 10-3) according to the present embodiment modulate the electrical signal with the identification numbers allocated to the stations themselves. A configuration example of the control unit 12 according to the present embodiment is illustrated in FIG. 12. The configuration example is a configuration example in which amplitude modulation (ASK) is performed on an electrical signal based on the identification number. In the control unit in the configuration example, a storage circuit 16, a second oscillation circuit (15-2), and a second switch have been added to the configuration of the control unit in the first and second embodiments.

The storage circuit 16 stores the identification number unique to the slave station. In the configuration example of FIG. 12, the identification number “010” is stored. The second oscillation circuit (15-2) is configured to perform oscillation at a lower frequency than a first oscillation circuit (15-1).

When the slave station 10 detects light, a first switch is turned on, and the first oscillation circuit (15-1) and the second oscillation circuit (15-2) perform oscillation to generate electrical signals. Signals 0, 1, and 0 corresponding to the identification number are output from the storage circuit 16 in order in accordance with the electrical signal (third electrical signal) from the second oscillation circuit (15-2). The signals 0, 1, and 0 corresponding to the identification number serve as an ON/OFF signal of the second switch, and the electrical signal output from the first oscillation circuit (15-1) is modulated through an ON/OFF operation of the second switch. With such a configuration, the slave station 10 can transmit the sound wave signal modulated with the signals corresponding to the identification number allocated to the slave station 10 itself to the master station 20. The master station 20 can identify from which slave station the master station 20 has received radio waves with the identification number obtained by demodulating an electrical signal obtained by converting the received sound signal.

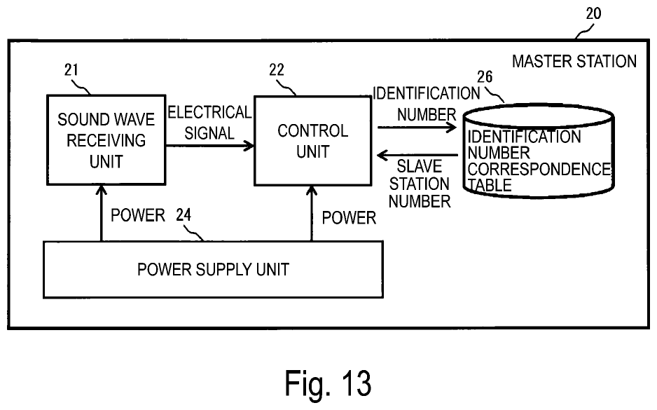

The configuration of the master station according to the present embodiment is illustrated in FIG. 13. The third embodiment is different from the first embodiment in that the master station 20 includes an identification number correspondence table 26 between identification numbers and slave station numbers. The control unit 22 of the master station 20 can identify from which slave station the master station 20 has received a radio wave by demodulating an electrical signal obtained by converting the received sound wave signal and with reference to the identification number correspondence table 26.

In the present embodiment, the configuration example in which amplitude modulation is performed on the electrical signal based on the identification number has been described. However, the scheme for modulating the sound wave is not limited to the amplitude modulation, and another modulation scheme may be used as long as it is possible to modulate the sound wave with the identification number and to transmit the modulated sound wave to the master station with the configuration. For example, phase modulation or frequency modulation may be used.

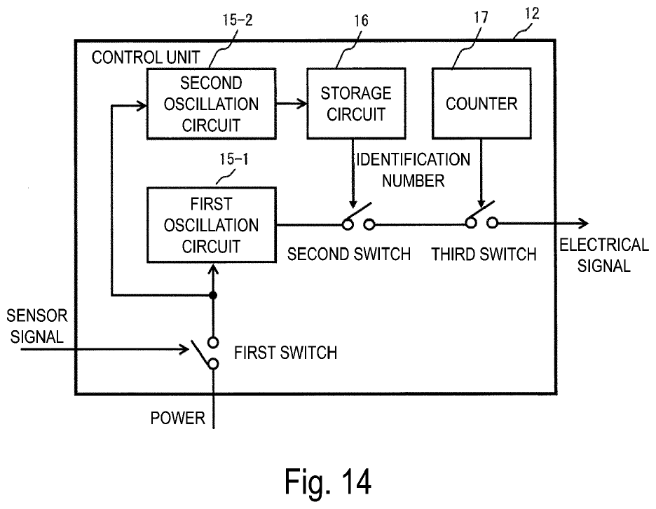

In the configuration of the control units in the slave stations in FIG. 12, when the frequencies of the first oscillation circuits in the slave stations are the same, collision of sound wave signals occurs if the plurality of slave stations transmit sound waves to the master station at the same time. To avoid this, the control units of the slave stations may be provided with collision avoidance functions. As illustrated in FIG. 14, for example, it is possible to achieve a configuration in which the control units 12 in the plurality of slave stations output electrical signals at mutually different timings, by adding counters 17 and third switches as illustrated in FIG. 14. In the configuration example, it is possible to cause the timing at which the sound wave signals are transmitted to the master station to deviate from each other and to avoid collision of the sound wave signals by setting values of the counters 17 of the control units 12 in the slave stations to be different from each other in advance.

As described above, according to the present embodiment, it is possible to enable communication at a low frequency using sound waves caused by oscillation of air and to provide a communication system that operates with an electronic circuit with a low operation frequency.

### REFERENCE SIGNS LIST

1 Communication system
10, 10-1 to 10-3 Slave station
11 Sensor
12 Control unit
13 Sound wave emitting unit
14 Power supply unit
15 Oscillation circuit
16 Storage circuit
17 Counter
20 Master station
21 Sound wave receiving unit
22 Control unit
23 Communication unit
24 Power supply unit
25 Frequency correspondence table
26 Identification number correspondence table

1.-8. (canceled)

9. A communication system comprising:
one or more slave stations, each of the slave stations comprising a sensor configured to detect a sensor signal, a controller configured to generate a first electrical signal at a predetermined frequency using the sensor signal, and a sound wave transmitter configured to convert the first electrical signal into a sound wave signal and to emit the sound wave signal; and
a master station comprising a sound wave receiver configured to receive the sound wave signal and to convert the sound wave signal into a second electrical signal, and a controller configured to detect that the sensor of one of the slave stations has detected the sensor signal based on the second electrical signal.

10. The communication system of claim 9, wherein the controller of each of the slave stations comprises a first switch configured to operate in accordance with the sensor signal, and a first oscillation circuit configured to generate the first electrical signal at the predetermined frequency in accordance with operation of the first switch.

11. The communication system of claim 10, wherein the sound wave transmitter of each of the slave stations comprises at least one transistor configured to operate in accordance with the first electrical signal, and a speaker configured to be driven by the at least one transistor.

12. The communication system of claim 9, wherein:
the communication system comprises a plurality of the slave stations,
the controller of each of the slave stations is configured to generate a plurality of the first electrical signals at mutually different frequencies, and
the controller of the master station is configured to identify each of the slave stations that has transmitted the sound wave signal based on a frequency of the second electrical signal.

13. The communication system of claim 10, wherein:
the communication system comprises a plurality of the slave stations,
the controller of each of the slave stations comprises a second oscillation circuit configured to generate a third electrical signal at a lower frequency than the first electrical signal in accordance with operation of the first switch, and to generate a signal corresponding to a unique identification number allocated to each of the slave stations in accordance with the third electrical signal, the first electrical signal being configured to be modulated based on the signal corresponding to the unique identification number, and
the controller of the master station is configured to identify each of the slave stations that has transmitted the sound wave signal based on the unique identification number obtained by demodulating the second electrical signal.

14. The communication system of claim 13, wherein the controller of each of the slave stations is configured to output the first electrical signal at a mutually different timing.

15. A communication method comprising:
by each of one or more slave stations:
detecting a sensor signal;
generating a first electrical signal at a predetermined frequency using the sensor signal;
converting the first electrical signal into a sound wave signal; and
emitting the sound wave signal; and
by a master station:
receiving the sound wave signal;
converting the sound wave signal into a second electrical signal; and
detecting that the slave station has detected the sensor signal based on the second electrical signal.

16. A slave station comprising:
a first oscillation circuit configured to generate a first electrical signal at a first frequency;
a photodiode configured to turn on the first oscillation circuit in response to detecting light;
a speaker configured to convert the first electrical signal into a sound wave signal when the first oscillation circuit is turned on; and
a first organic transistor configured to drive the speaker.

17. The slave station of claim 16 further comprising:
a second oscillation circuit configured to generate a second electrical signal at a second frequency, the second frequency lower than the first frequency, the photodiode being configured to turn on the second oscillation circuit in response to detecting the light;
a storage circuit configured to output an identification number in accordance with the second electrical signal; and
a modulator configured to modulate the first electrical signal with the second electrical signal.

18. The slave station of claim 16, wherein the first oscillation circuit comprises a resistor, a capacitor, and a logical inverter.

19. The slave station of claim 18, wherein the logical inverter comprises a second organic transistor.
